(19) United States
(12) Patent Application Publication
(10) Pub. No.: US 2021/0206468 A1
(43) Pub. Date: Jul. 8, 2021

(54) PROTECTIVE COVERS FOR USE WITH AIRCRAFT CARGO HOLDS

(71) Applicant: Creative Solutions, Inc., Lakewood, WA (US)

(72) Inventor: William J. Boyer, Jr., Black Diamond, WA (US)

(21) Appl. No.: 17/021,481

(22) Filed: Sep. 15, 2020

Related U.S. Application Data
(63) Continuation of application No. 15/644,693, filed on Jul. 7, 2017, now abandoned.
(60) Provisional application No. 62/360,276, filed on Jul. 8, 2016.

(51) Int. Cl. B64C 1/20; B64C 1/06; B60N 3/04

(52) U.S. Cl. CPC B64C 1/20; B64C 1/066; B64C 1/22; B60N 3/048; B60N 3/046

(57) ABSTRACT

Protective covers (e.g., “liners”) for use in protecting aircraft cargo hold floors from potentially harmful or dangerous fluids and other substances, and from physical damage, are described herein. In some embodiments, the cargo pit liners described herein can include a plurality of raised portions and adjacent recesses that provide a protective barrier between cargo and a floor of the cargo pit. The raised portions can facilitate movement of cargo and improve impact resistance, and the recesses can collect and retain potentially detrimental fluids.

### RELATED APPLICATIONS

This application is a continuation of U.S. patent application Ser. No. 15/644,693, titled Protective Covers for Use with Aircraft Cargo Holds, filed Jul. 7, 2017, which claims priority to and the benefit of U.S. Provisional Patent Application No. 62/360,276, titled Protective Covers for Use with Aircraft Cargo Holds, filed Jul. 8, 2016, both of which are incorporated herein in their entirety by reference thereto.

### TECHNICAL FIELD

The disclosure relates generally to covers and cover systems for protecting floors on aircraft cargo holds and facilitating the loading/unloading of cargo.

### BACKGROUND

Commercial aircraft have been used to transport goods and materials for many years. Some types of cargo, however, can leak liquids or other substances onto the floor of the aircraft cargo hold (also known as a “cargo pit”) which may be corrosive, slippery, sticky, or otherwise potentially detrimental to the aircraft and/or personnel working in the cargo hold. For example, some aircraft are used to transport thousands of pounds of fish or crab in boxes, which can leak corrosive saltwater onto the floor of the cargo pit. Other aircraft may transport powered wheelchairs and other devices which carry batteries that can leak corrosive acid. Similarly, the transportation of machinery can result in oil leaking onto the cargo hold floor, and the transportation of bees and bee hives can result in the leakage of honey. Whether slippery or sticky, the presence of such substances can hinder the safe loading and unloading of cargo into and out of the cargo hold.

Some airlines lay thin sheets of plastic onto the floors of cargo pits to protect against fluid leakage. They may also place a layer of absorbent cloth over the plastic or under the plastic sheets to absorb liquids that get past the plastic sheets. These solutions are largely unsatisfactory, however, because the placement and movement of cargo on top of the plastic sheet tends to cause the sheet to bunch up, tear, or otherwise be displaced or damaged, such that they are largely ineffective in sealing the cargo pit floor from liquids. Additionally, such measures are largely ineffective at preventing dents, gouges, and other physical damage to the cargo hold floor from machinery and/or other cargo that is dropped onto the floor.

### BRIEF DESCRIPTION OF THE DRAWINGS

FIG. 1A is a top isometric view of an aircraft cargo pit liner configured in accordance with an embodiment of the present technology, and FIG. 1B is a corresponding bottom isometric view of the cargo pit liner.

FIG. 2 is an isometric view of a typical transport aircraft cargo pit.

FIG. 3A is a top isometric view of an aircraft cargo pit liner installed in an aircraft cargo pit in accordance with an embodiment of the present technology.

FIG. 3B is a top isometric view of a plurality of cargo pit liners installed in the aircraft cargo pit in accordance with another embodiment of the present technology.

FIG. 3C is an enlarged, partial top isometric view of adjacent cargo pit liners interconnected in accordance with embodiment of the present technology.

FIG. 4A is a top isometric view of an aircraft cargo pit liner configured in accordance with another embodiment of the present technology.

FIG. 4B is a top isometric view of the cargo pit liner installed in an aircraft cargo pit in accordance with an embodiment of the present technology.

FIG. 5A is a partially exploded top isometric view of an aircraft cargo pit liner configured in accordance with an embodiment of the present technology.

FIG. 5B is a top isometric view of the pit liner of FIG. 5A installed in an aircraft cargo pit.

FIG. 6 is an isometric view of a plurality of cargo containers stacked on top of a cargo pit liner in an aircraft cargo pit in accordance with an embodiment of the present technology.

FIG. 7 is a top isometric view of an aircraft cargo pit liner configured in accordance with another embodiment of the present technology.

FIG. 8 is a top isometric view of an aircraft cargo pit liner similar to FIG. 7 and with a top sheet that is shown partially raised for illustration purposes.

FIG. 9 is a top isometric view of the aircraft cargo pit liner of FIG. 8 with the top sheet in the lowered, fixed position.

FIG. 10 is a top isometric view of a pair of interconnected aircraft cargo pit liners of FIG. 9.

FIG. 11 is a top isometric view of a plurality of interconnected aircraft cargo pit liners of FIGS. 7 and 9.

Appendix A includes additional photos, drawings and/or illustrations of one or more embodiments of the present technology.

### DETAILED DESCRIPTION

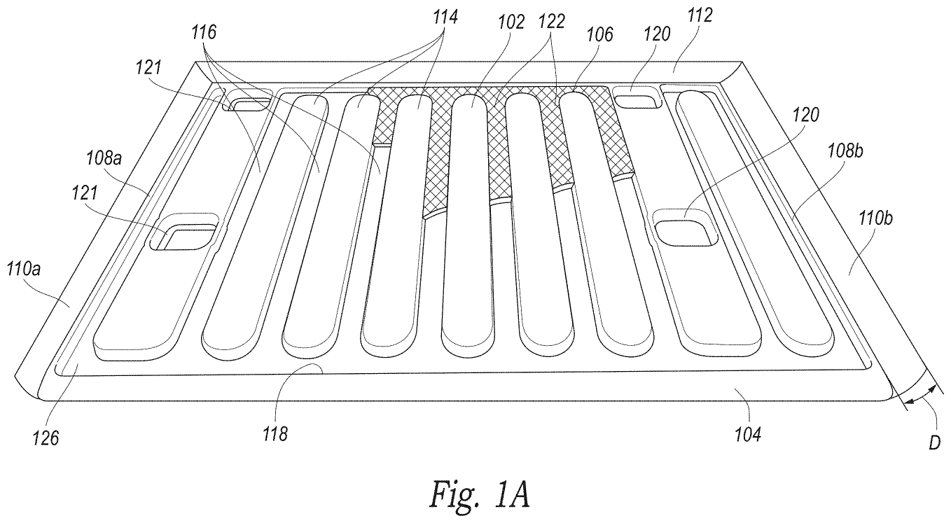

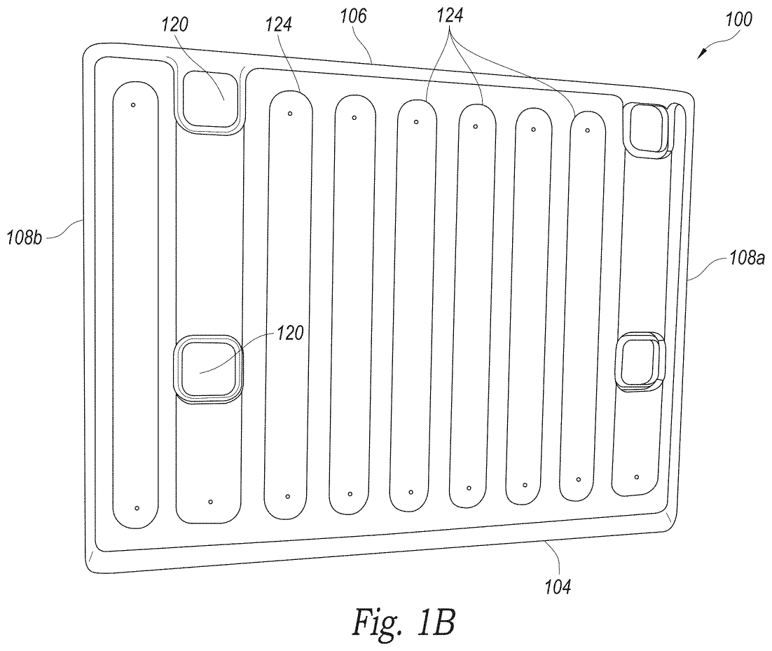

The following disclosure describes various embodiments of structures and systems that can be used to protect the floor of an aircraft cargo hold (also referred to as a cargo “bay” or cargo “pit”) from gouges, scratches, punctures, and other types of physical damage, from corrosive liquids and other substances, and/or from slick, sticky, or other types of liquids and substances that can make use of the cargo hold difficult or potentially dangerous. Certain details are set forth in the following description and in FIGS. 1-11 to provide a thorough understanding of various embodiments of the present technology. In other instances, well-known structures, materials, operations and/or systems often associated with aircraft cargo pits, plastic materials and structures, etc. are not shown or described in detail in the following disclosure to avoid unnecessarily obscuring the description of the various embodiments of the technology. Those of ordinary skill in the art will recognize, however, that the present technology can be practiced without one or more of the details set forth herein, or with other structures, methods, components, and so forth.

The terminology used below is to be interpreted in its broadest reasonable manner, even though it is being used in conjunction with a detailed description of certain examples of embodiments of the technology. Indeed, certain terms may even be emphasized below; however, any terminology intended to be interpreted in any restricted manner will be overtly and specifically defined as such in this Detailed Description section.

The accompanying Figures depict embodiments of the present technology and are not intended to be limiting of its scope. The sizes of various depicted elements are not necessarily drawn to scale, and these various elements may be arbitrarily enlarged to improve legibility. Component details may be abstracted in the Figures to exclude details such as position of components and certain precise connections between such components when such details are unnecessary for a complete understanding of how to make and use the invention.

Many of the details, dimensions, angles and other features shown in the Figures are merely illustrative of particular embodiments of the disclosure. Accordingly, other embodiments can have other details, dimensions, angles and features without departing from the spirit or scope of the present invention. In addition, those of ordinary skill in the art will appreciate that further embodiments of the invention can be practiced without several of the details described below.

In the Figures, identical reference numbers identify identical, or at least generally similar, elements. To facilitate the discussion of any particular element, the most significant digit or digits of any reference number refers to the Figure in which that element is first introduced. For example, element 110 is first introduced and discussed with reference to FIG. 1.

FIG. 1A is top isometric view of a cover 100 configured in accordance with an embodiment of the present technology. The cover 100 can be used to protect the floor of an aircraft cargo hold or “pit” from detrimental fluid leakage, physical damage, etc. Accordingly, the cover 100 is referred to herein as a “pit liner 100” for ease of reference. In the illustrated embodiment, the pit liner 100 includes a liner body 102 having a generally rectangular planform with a front edge 106 space apart from a rear edge 104, and a left side edge 108a spaced apart from a right side edge 108b. The liner body 102 further includes a plurality of raised portions 114 spaced apart by corresponding channels or recesses 116. A raised border 118 extends around the outer edges of the liner body 102 to contain liquids and other substances that may collect in the recesses 116 during use and prevent them from escaping onto the cargo pit floor.

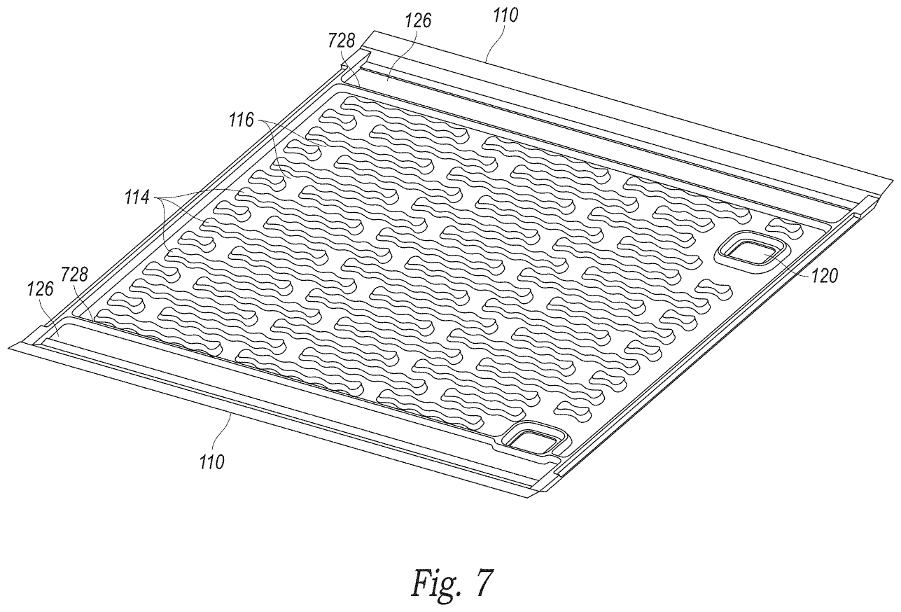

The raised border 118 of the illustrated embodiment defines a channel 126 extending around at least a portion of the perimeter of the pit liner 100. The channel 126 may be integrated with the recesses 116 so that fluid or debris can collect and move between the recesses 116 and the channel 126 (as shown in FIG. 1A). In other embodiments, the channel 126 or portions of the channel 126 can be isolated from and out of fluid communication with the recesses 116, so there is a barrier between the channel 126 and the one or more of recesses 116 (shown below in FIGS. 7-10) to restrict the movement of the fluid or debris into or out of some of the recesses 116 and/or the channel 126. Additionally, the raised border 118 can also form an angled “ramp” at the rear edge 104 so that cargo (e.g., cargo boxes) can be easily slid over the ramp and onto the pit liner 100 when loading cargo for transport. In some embodiments, the raised portions 114 can extend between about 0.12 inch and about 1.5 inches, or about 0.25 inch and about 1 inch, or about 0.5 inch and about 0.75 inch above the bottom of the adjacent recesses 116. In other embodiments, the raised portions 114 can have other shapes, sizes, heights, etc. Additionally, in some embodiments, the upper surfaces of the raised portions 114 can be generally flat and at the same height as the raised border 118, or at least approximately the same height, so that cargo can slide or otherwise move easily over the pit liner 100 without snagging or otherwise getting caught on the liner 100.

In the illustrated embodiment, the liner body 102 further includes a plurality of apertures or openings 120 positioned to align with corresponding anchor points on an aircraft cargo pit (not shown) when the pit liner 100 is positioned in the cargo pit. The apertures or openings 120 can have a bottom flange 121 positioned immediately atop the cargo floor that extends radially inward toward the anchor points. In one embodiment, tape or other sealant is provided between the bottom flange 121 and the cargo floor to prevent fluid or debris from getting under the pit liner 100 via the openings 120. The sealed openings 120 can also effectively act as a reservoir to contain fluid or debris, and these reservoir areas can be cleaned as needed. As described in greater detail below, providing access to the anchors enables the pit liner 100 to be secured to the pit floor by means of straps (e.g., FAA-certified straps) or other suitable and/or certified apparatuses that connect to the anchors via the openings 120.

In addition of the foregoing features, the pit liner 100 can further include a left side flap 110a extending generally outward from the left side edge 108a, a right side flap 110b extending generally outward from the right side edge 108b, and a corresponding front flap 112 extending generally upward from the front edge 106. The side flaps 110 can extend for a distance D of from about 0.5 inches to about 36 inches or more, or from about 1 inch to about 24 inches, or from about 1 inch to about 10 inches, or from about 1 inch to about 7 inches, or from about 3 inches to about 6 inches outwardly from the corresponding side edge 108. The side flaps 110 and the front flap 112 can provide a continuous sealing member that extends around the sides and the front edge of the liner body 102 to prevent undesirable fluids and/or other substances that fall onto the liner 100 from leaking onto the pit floor around the forward or side edges of the pit liner 100. The side flaps 110 and front flap 112 can be removeably attached to the edges of the liner body 102. The flaps 110/112 can be secured in place on the edge of the liner body 102 with tape, adhesive, aviation Velcro®, or other suitable attachment mechanism. In certain embodiments, the flaps 110/112 may be permanently affixed to the sides of the pit liners.

In certain embodiments, the side flaps 110 and front flap 112 can be secured to the cargo pit wall by tape (e.g. VHB tape, double-sided tape, etc.) adhesive, aviation Velcro® or other suitable attachment mechanism. Securing the side flaps 110 to the cargo pit wall can help protect the cargo pit wall, as well as helping to avoid or reduce an edge transition between the cargo pit wall and the side flap 110. This configuration will also serve to form a sealed transition to prevent liquids and/or other substances from leaking between the side flaps 110 and the cargo pit wall. In certain embodiments, the side flaps 110 may be permanently affixed to the cargo pit wall and removably attachable to one or more of the pit liners 100. As described in greater detail below, the pit liner 100 can be used in conjunction with additional pit liners to cover the entire pit floor, or at least approximately the entire pit floor, by overlapping or otherwise joining adjacent forward and rear edges of adjacent liners.

In some embodiments, the pit liner 100 can further include an absorbent material 122 that is patterned or otherwise configured to fit within one or more of the recesses 116 and/or the channel 126 to absorb liquids that may fall onto the pit liner 100 in use. Such absorbent materials can include, for example, natural and synthetic woven materials configured to absorb and contain fluids. The absorbent material 122 can be sized so that it does not extend above the height of the adjacent raised portions 114 and interfere with cargo movement. The absorbent material 122 can be removeably adhered (e.g., via contact adhesive) and/or mechanically fastened to the liner body 102 so that it can be easily removed and disposed of as needed.

FIG. 1B is an isometric bottom view of the pit liner 100 configured in accordance with an embodiment of the present technology. In the illustrated embodiment, the pit liner 100 includes a plurality of inserts 124 positioned in the recesses which correspond to the backside of the raised portions 114 shown in FIG. 1A. The inserts 124 can be made from various materials that provide stiffness and/or impact resistance to the pit liner 100. For example, in some embodiments, the inserts 124 can be made from a sheet or panel of honeycomb material, such as a composite honeycomb that includes a honeycomb core with opposing composite (e.g., graphite/epoxy) face sheets. Such materials can include aircraft certified composite materials that are lightweight, stiff, and relatively impact resistant. In other embodiments, the inserts 124 can be made from other types of suitable lightweight materials. In yet other embodiments, the inserts 124 can be omitted.

Referring to FIGS. 1A and 1B together, the pit liner 100 can be manufactured using various materials and methods. For example, in some embodiments, the pit liner can be formed from plastic, such as thermoformed plastic that is thermally and/or vacuum molded to the desired shape. In other embodiments, the pit liner can be formed from plastic using other methods, including injection molding, blow molding, rotational molding, etc. Additionally, in some embodiments, the liner body 102 can be thermoformed over the inserts 124 (FIG. 1B) so that the inserts 124 mold the raised portions 114 to the desired shape. The pit liner 100 can be molded from various types of plastics having various types of thicknesses. In some embodiments, for example, the pit liner 100 may have a material thickness of from about 0.01 inch to about 0.25 inch, or from about 0.02 inch to about 0.12 inch, or about 0.04 inch to about 0.08 inch. The pit liner 100 can be molded from a Kydex, which is a thermoplastic acrylic-polyvinyl chloride (PVC) material manufactured by Sekisui SPI. Other suitable acrylic-polyvinyl chloride materials are manufactured by Emco Plastics and Interstate Plastics. Additionally, the liner 100 can also be made from a Boltaron thermoplastic sheet, which is a proprietary, fire retardant, extruded PVC/acrylic alloy offering extreme durability, chemical resistance, etc. In other embodiments, other suitable plastics, such as other FAA certified flame retardant plastics, can be used. In yet other embodiments, the pit liner 100 can be formed from other materials, including metals (e.g., stainless steel, aluminum, etc.), composites, etc. In certain embodiments, it will be advantageous for the pit liner 100 to be formed from material that can be patched or repaired, such as by using Kydex patches and/or tape to cover scratches, holes, dents, deformations, or other minor damage that may occur during use of the pit liners 100 in the cargo holds. If the pit liners 100 experience excessive wear, damage, or deformations, the pit liner 100 can simply be easily and quickly replaced without creating a substantial delay in operation of the aircraft.

The dimensions and relative shapes of the features of the pit liner 100 shown in FIGS. 1A and 1B are representative of one embodiment. Accordingly, other embodiments can have other shaped raised portions 114 and/or recesses 116 without departing from the present disclosure. For example, in other embodiments, the raised portions 114 may be narrower and placed closer together to provide higher or other different impact resistance. In yet other embodiments, the recesses 116 can have different depths or widths so that the pit liner 100 can hold more or less fluid. In yet further embodiments, the opening 120 can be omitted, and the pit liner 100 can be secured to the pit using other techniques and/or materials, such as adhesive materials (e.g., tapes, such as double-sided tapes), fasteners, clips, hook-and-loop materials, other aircraft certifiable securing materials or features, etc.

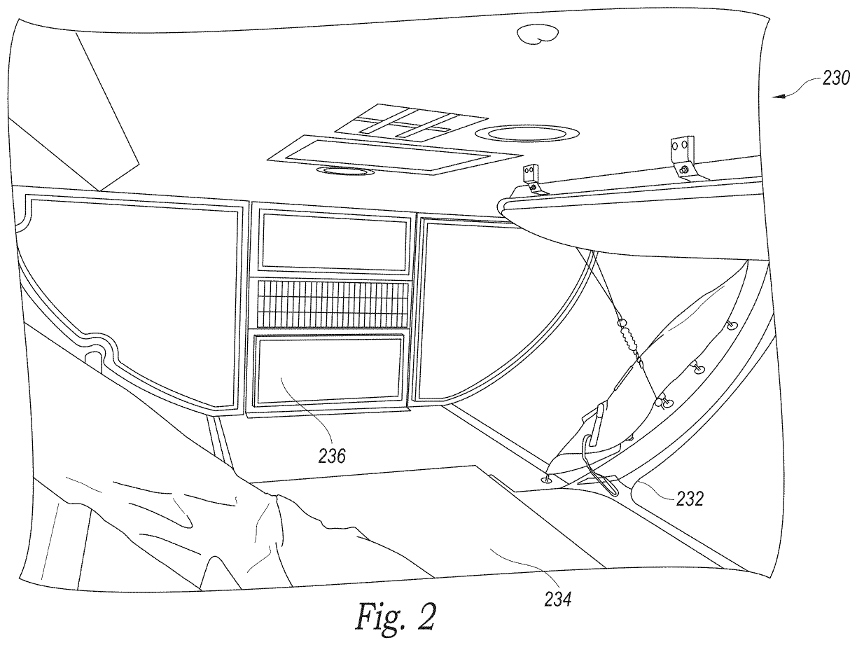

FIG. 2 is an isometric view of a typical aircraft cargo pit 230 (such as a Boeing 737 cargo pit). The cargo pit 230 includes a side door 232 for loading cargo onto a pit floor 234. The fore and aft ends of the cargo pit 230 are bounded by a corresponding bulkhead 236. As FIG. 2 illustrates, the cargo pit 230 occupies the lower half of the aircraft fuselage and, accordingly, has generally partially cylindrical-shaped sidewalls. The floor 234, however, is flat. As noted above, the floor 234 can sustain damage from punctures, gauges, dents, etc., that occur during the loading and unloading of machinery, building materials, and/or other types of cargo. If the damage is substantial, the floor 234 may have to be repaired or replaced. Additionally, some types of cargo (e.g., seafood, batteries, bees, etc.) may leak undesirable fluids onto the floor 234 which may cause corrosion of the floor 234 or its substructure and/or present operational hazards from slipping, stickiness, etc. These concerns can be mitigated with the use of the pit liners described herein.

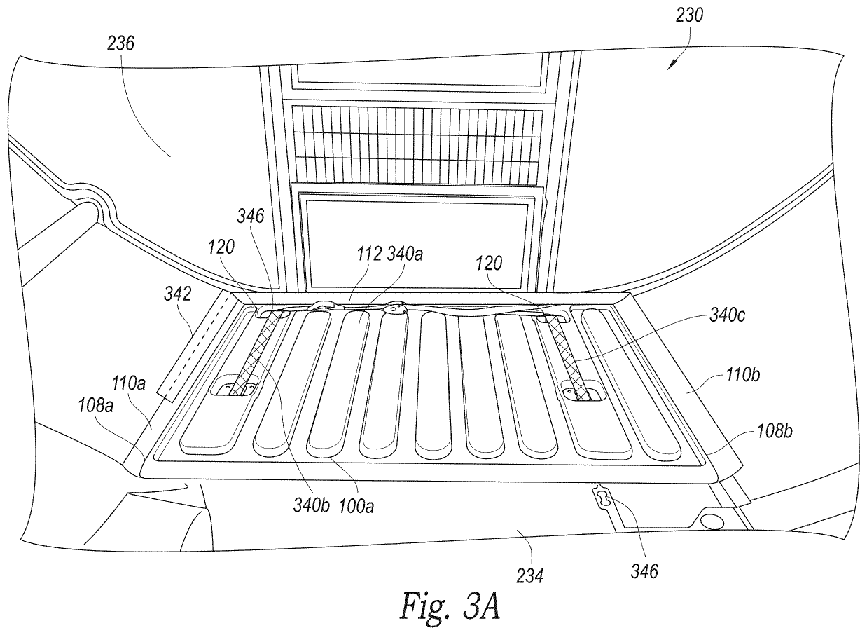

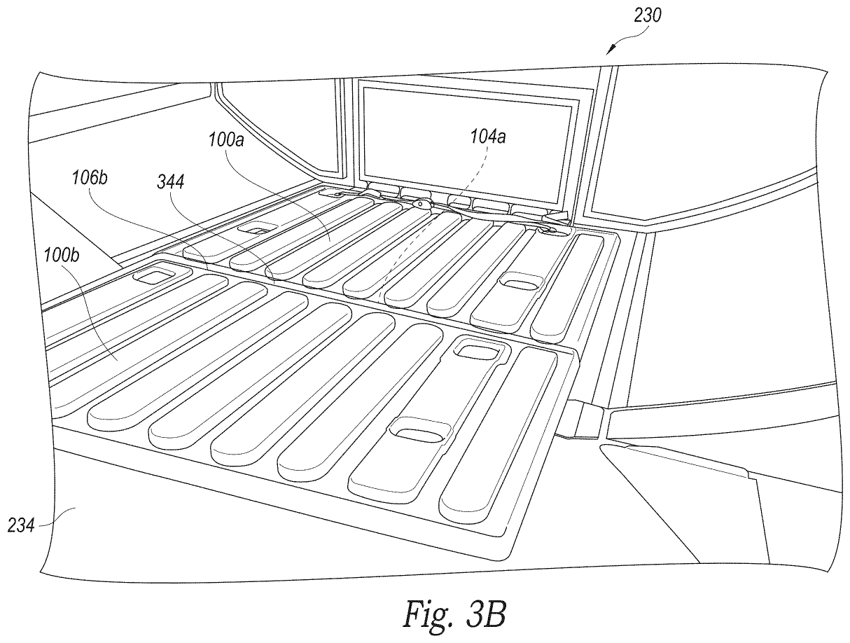

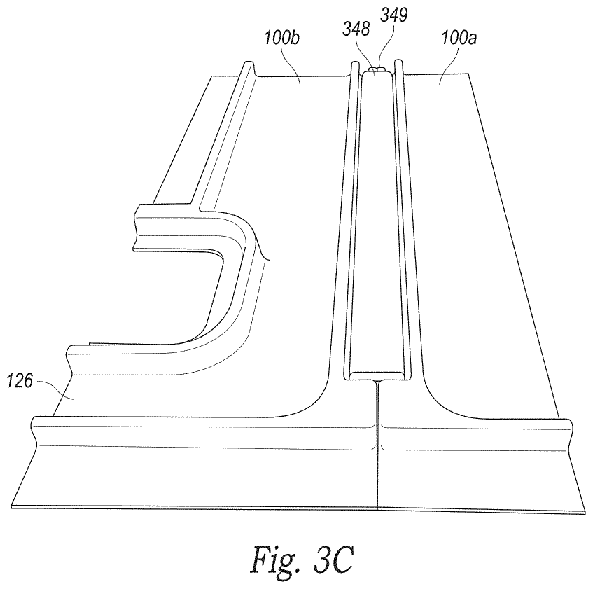

FIG. 3A is a top isometric view of the cargo pit 230 with a first pit liner 100a installed therein in accordance with an embodiment of the present technology. FIG. 3B is a corresponding top isometric view of the cargo pit 230 after a second pit liner 100b has been installed on the pit floor 234 adjacent to the first pit liner 100a. Referring first to FIG. 3A, in the illustrated embodiment the first pit liner 100a is positioned in the cargo pit 230 so that the front flap 112 is positioned against the forward bulkhead 236. Additionally, the left and right side edges 108a, b are positioned at the corresponding left and right edges of the pit floor 234, so that the side flaps 110a, b lay flat against the curved side walls of the cargo pit 230. Laying the front flap 112 and the side flaps 110 against the adjacent surfaces of the cargo pit 230 can provide a seal that prevents corrosive liquids and/or other substances from leaking onto the pit floor 234 from around the edges of the pit liner 100a. This seal can be enhanced by the application of tape 342 (e.g., cargo pit adhesive tape) to the outer edges of the side flaps 110 and the front flap 112 to attach and seal the outer edges to the adjacent cargo pit surfaces. In another embodiment, this seal can be enhanced by attaching the side flaps 110 and the front flap 112 to the adjacent cargo pit surfaces using double stick tape, Velcro®, fasteners, or other suitable attachment techniques.

In the illustrated embodiment, the first pit liner 100a is secured to the pit floor 234 by means of a flexible strap 340a that connects to corresponding anchor points 346 on the pit floor 234 through the forward openings 120. In other embodiments, the pit liner 100 can also be attached to the pit floor 234 by means of additional straps 340b, c that run fore and aft and attach to anchor points 346 through the corresponding side openings 120. In yet other embodiments, the straps 340a-c can be omitted, and the pit liner 100a can be attached to the pit floor 234 and/or adjacent surfaces by means of adhesive (e.g., a double-sided adhesive tape), fasteners, and/or other mechanical means. In such other embodiments, the openings 120 can be omitted.

Referring next to FIG. 3B, as noted above in many applications it will be desirable to cover the entire pit floor 234, or at least approximately the entire pit floor 234, to protect it against structural damage and/or corrosive, slippery, sticky or other liquids. In such embodiments, a plurality of the pit liners 100 can be positioned adjacent to each other in an interlocking or otherwise cooperative manner to create a continuous, or at least approximately continuous, cover over the pit floor 234. For example, as shown in FIG. 3B, a front edge 106b of a second pit liner 100b can include a lip 344 that engages or otherwise cooperates with the rear edge 104a of the first pit liner 100a to create a “ramp” between the two pit liners. The ramp can provide a smooth transition between the adjacent pit liners 100 to facilitate sliding or other movement of cargo over the surface. Additionally, the ramp formed by the lip 344 can also provide an efficient seal to prevent the leakage of fluids and/or other undesirable substances between the adjacent pit liners 100. In some embodiments, the lip 344 can include a downwardly-curved portion of pit liner material that extends over the raised border 118 on the rear edge 104a (FIG. 1A) of the first cargo liner 100a. In other embodiments, the second cargo liner 100b (and/or the first cargo liner 100a) can include other structural features to provide a suitable interface between the adjoining pit liners 100a, b. In further embodiments, it is contemplated that a single pit liner configured in accordance with the teachings herein can be configured to cover an entire cargo pit floor.

FIG. 3C is an enlarged, partial isometric view of two adjacent interconnected pit liners 100a and 100b. As the view illustrates, adjacent pit liners 100a and 100b can be releasably connected to each other in a generally co-planar arrangement using a removable retention clip 348 that attaches to the respective leading and trailing edges of adjacent pit liners 100a and 100b. In one embodiment, contoured engagement features 349 are formed in the leading and/or trailing edges of the pit liners 100a and 100b, and the retention clip 348 is a “C-shaped” clip with the opening facing downward. The C-shaped retention clip 348 is configured to elastically deflect to temporarily enlarge the opening as the clip 348 is pushed over the engagement features 349 until the clip 348 snaps into place over the adjacent engagement features 349 and locks the pit liners 100a and 100b together. The leading and/or trailing edge portions of adjacent pit liners 100a and 100b can be provided with access recesses adjacent to the clip 348 when installed that allow a screwdriver or other tool to engage and remove an installed retention clip 348, such as when the pit liners 100a and 100b need to be replaced or otherwise separated from each other.

In another embodiment, the contoured engagement features 349 on the leading and/or trailing edge portions of the pit liner 100 can be sized so that, when the retention clip 348 is installed, the upper surface of the clip 348 is substantially planar with or slightly recessed from top surface of the pit liner 100. In some embodiments, tape or other covering can be positioned over the clips 348 and the joint between adjacent pit liners 100a and 100b to help protect the clips 348 and/or the leading and/or trailing edge portions of the pit liners 100. This configuration helps ensure that the clips 348 do not create an interference when cargo is slid over the top surface of the installed pit liners 100. This also protects the clips 348 from being inadvertently dislodged when cargo is slid over the joint between adjacent pit liners 100. In certain embodiments where the retention clip 348 is used to connect adjacent pit liners, the pit liners do not include the angled “ramp” at the forward or rear edge of the pit liners.

In operation, the aircraft operator can install the pit liners 100a, b, etc., in the cargo pit 230 prior to loading of cargo. To load cargo, the cargo handlers position the cargo onto the cargo liner 100 adjacent to the pit door 232, and then slide or otherwise move the cargo (or cargo container, if applicable) to one end of the cargo pit 230. As noted above, the pit liner raised portions 114 (FIG. 1A) facilitate movement of the cargo back and forth in the cargo pit 230. If a portion of the cargo is dropped or otherwise impacts the pit liners 100, the pit liners 100 can absorb the impact and protect the pit floor 234 from damage. Additionally, if the cargo (e.g., frozen seafood, batteries, etc.) leaks fluids during transport, the pit liners 100 can contain the fluid and prevent it from leaking out and onto the pit floor 234 and causing damage and/or an unsafe work environment.

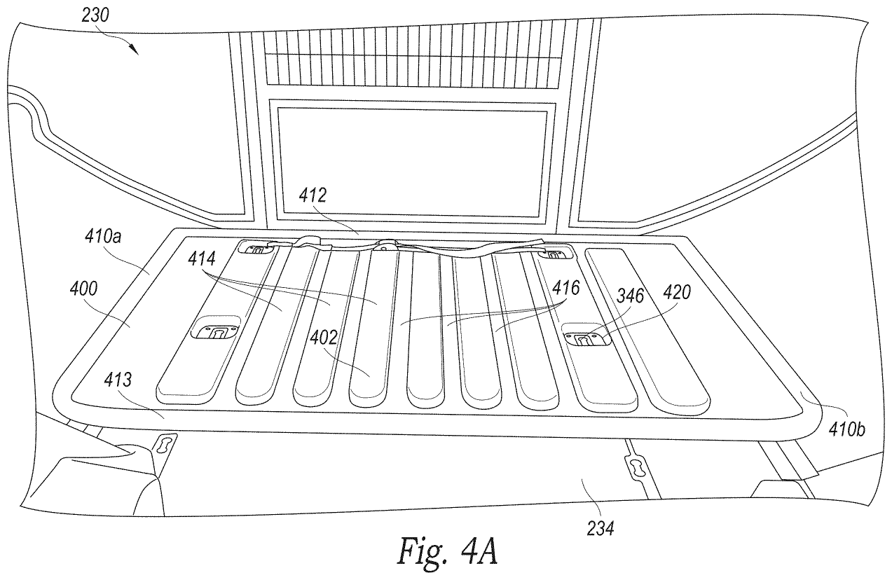

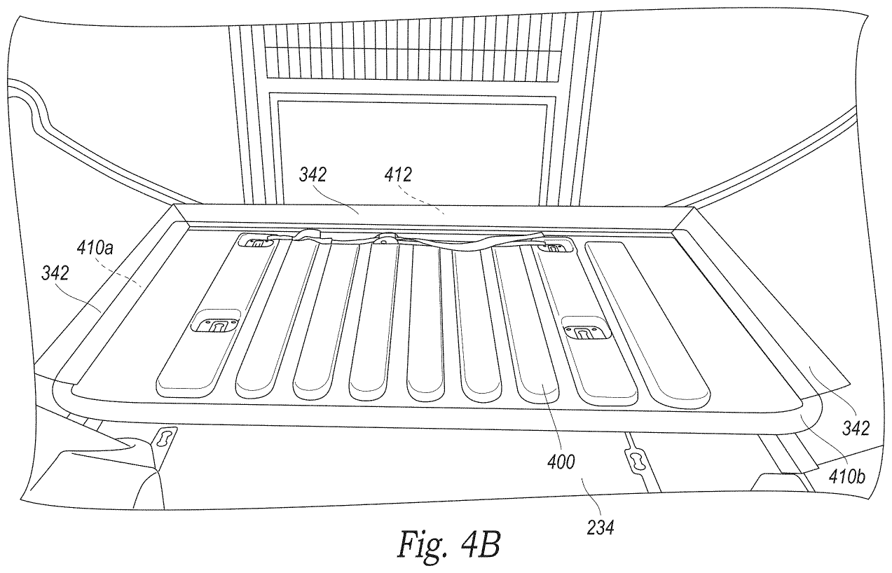

FIG. 4A is a top isometric view of an aircraft cargo pit liner 400 configured in accordance with another embodiment of the present technology. The pit liner 400 is at least generally similar in structure and function to the pit liner 100 described in detail above. For example, the pit liner 400 can include a liner body 402 having a plurality of parallel and longitudinally arranged raised portions 414 separated by a plurality of corresponding recesses 416 disposed therebetween. Additionally, in the illustrated embodiment the liner body 402 can include one or more openings 420 positioned to align with corresponding anchor points 346 on the floor 234 of the cargo pit 230.

In the illustrated embodiment, the pit liner 400 lacks a raised border (such as the raised border 118 shown in FIG. 1A) extending along the side edges of the liner body 402. Instead, the pit liner 400 includes side flaps 410a, b that extend continuously along the side edges of the pit liner 400 and cooperate with a corresponding forward flap 412 and aft border 413 to provide a continuous lip or rim around the liner body 402. This rim can prevent liquids that collect in the recesses 416 of the liner body 402 from escaping from the liner and flowing onto the floor 234 of the cargo pit 230. Additionally, the aft border 413 of the liner body 402 can provide an angled ramp that facilitates sliding or otherwise moving cargo (e.g., cargo boxes) from the cargo pit floor 234 onto the pit liner 400. As shown in FIG. 4B, the side flaps 410a, b and the forward flap 412 can be sealably attached to the adjacent side surfaces and forward bulkhead, respectively, of the cargo pit 230 with a suitable adhesive tape 342, such as conventional cargo tape. As discussed in detail above, sealably attached the outer perimeter of the pit liner 400 to the adjacent surfaces of the cargo pit 230 can secure the pit liner 400 in place and further help retain liquids in the pit liner 400.

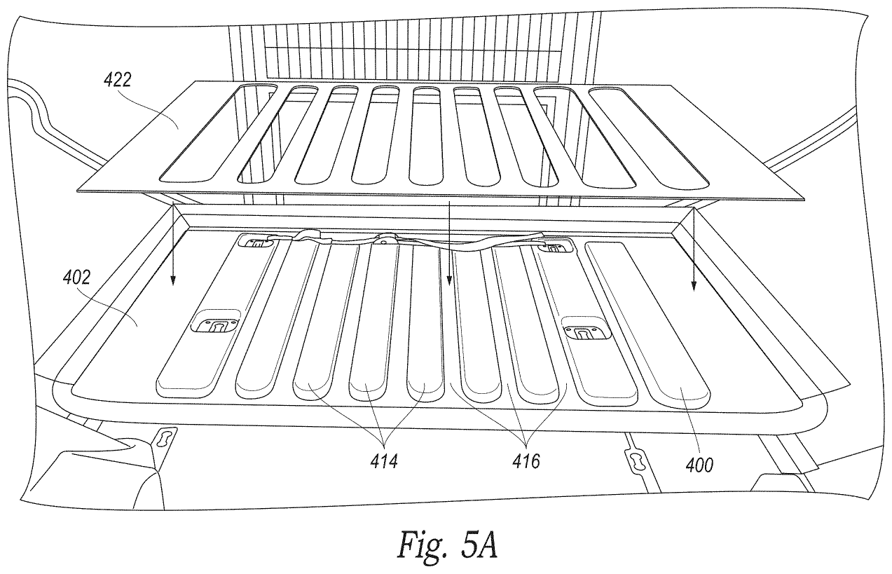

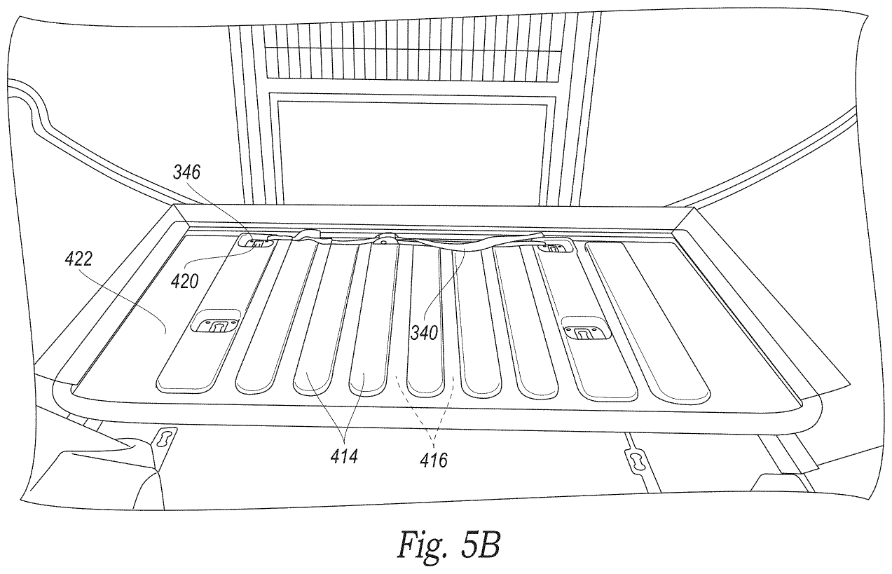

FIG. 5A is a partially exploded top isometric view illustrating a layer of absorbent material 422 before it has been installed on the liner body 402. As described above with reference to the absorbent material 122 shown in FIG. 1A, the absorbent material 422 can be made of organic and/or synthetic cloth, sponge materials, and/or other suitably absorbent materials known in the art. The absorbent material 422 can be cut or otherwise formed in a pattern that fits neatly into the recesses 416 and around the raised portions 414 of the liner body 402 to absorb and contain any liquids that may fall onto the pit liner 400 in use.

FIG. 5B is a top isometric view showing the absorbent material 422 installed on the pit liner 400. As this view illustrates, the absorbent material 422 can have a thickness that is slightly less than the height of the raised portions 414, so that the raised portions 414 protrude slightly above the absorbent material 422 to provide a contact surface for sliding and supporting cargo thereon. This feature can also prevent any liquid contained in the absorbent material from contacting the cargo containers (e.g., cardboard containers) and damaging or otherwise compromising the containers. The absorbent material 422 can be held in place on the liner body 402 with a suitable adhesive, such as a double-sided adhesive tape positioned between the underside of the absorbent material 422 and the liner body 402. As noted above, the absorbent material 422 can be easily replaced if and when it becomes saturated with liquid or otherwise ineffective from use.

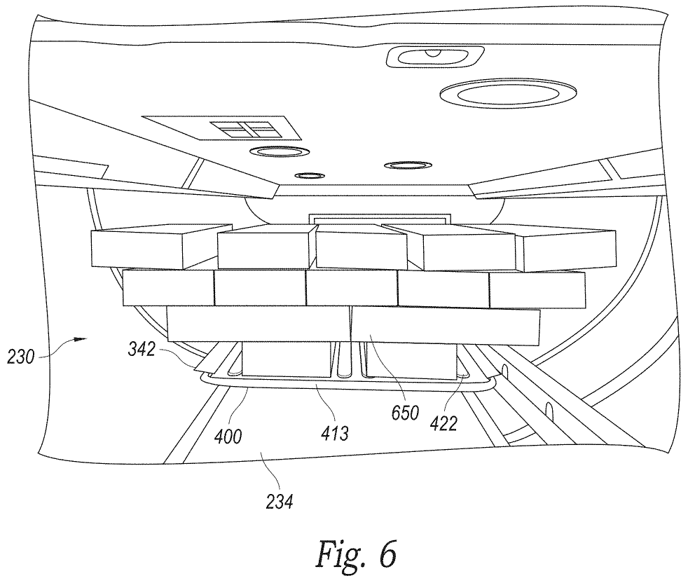

FIG. 6 is an isometric view of the aircraft cargo pit 230 in which a plurality of cargo containers, such as cardboard boxes containing frozen seafood, have been loaded on top of the pit liner 400 described in detail above. As this view illustrates, the absorbent material 422 has been installed on top of the liner body 402 to absorb any liquids (e.g., saltwater) that may leak off the cargo 650 during transport. Additionally, the side edges of the pit liner 400 (and the front edge—not shown) have been sealably attached to the side walls of the cargo pit 230 with the tape 342. The rear edge 413 of the pit liner 400 can provide an angled ramp that facilitates sliding or other movement of the cargo 650 onto the pit liner 400 from the pit floor 234 during the loading process.

FIG. 7 is a top isometric view of another embodiment of the pit liner 100. As the view illustrates, the plurality of raised portions 114 can be offset from each other in various patterns, wherein individual raised portions 114 do not traverse the entire length of the liner body 102. The plurality of raised portions 114 can be positioned in a multitude of designs that define the recesses 116, and can be of a variety of different shapes and sizes within the scope of the present technology.

In certain embodiments, a perimeter channel 126 is provided around the perimeter or selected portions of the perimeter of the pit liner 100 and is configured to catch debris, fluids, and other leakage from, for example, cargo placed atop the pit liner 100. In certain embodiments, the channel 126 is on the left side edge 108a and/or the right side edge 108b of the pit liner 100. In other embodiments, the channel 126 can be on the front side edge and/or rear side edge of the pit liner. In yet other embodiments, the channel 126 is on the left side edge, the right side edge, and at least one of the front side edge or the rear side edge. One skilled in the art will recognize that a variety of channel configurations extending around at least a portion of the perimeter of the pit liner can be provided and are within the scope of the present technology. In one embodiment, the channel 126 on either or both of the left side edge and right side edge can be connected with the channel 126 on the front side edge or the rear side edge so that fluid and other debris can move around the perimeter of the liner body within the channel 126. In alternative embodiments, each portion of the channel 126 can be a separate reservoir.

Furthermore, the channel 126 may be in fluid communication with the plurality of recesses 116 so that fluid or debris can flow or otherwise move freely between the recesses 116 and the channel 126 (as shown in FIG. 1A). In another embodiment, the channel 126 can be isolated and out of fluid communication with the recesses 116 so that there is a barrier 728 between the channel 126 and the recesses 116 (as shown in FIG. 7). The barrier 728 defines the inner perimeter of the channel 126 and blocks fluid and other debris from leaving the channel 126.

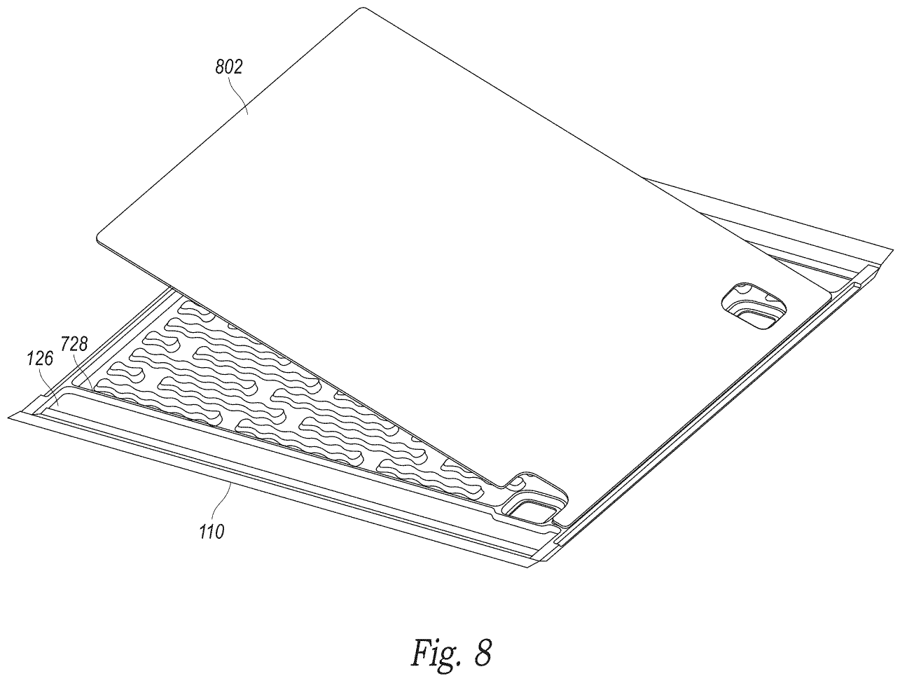

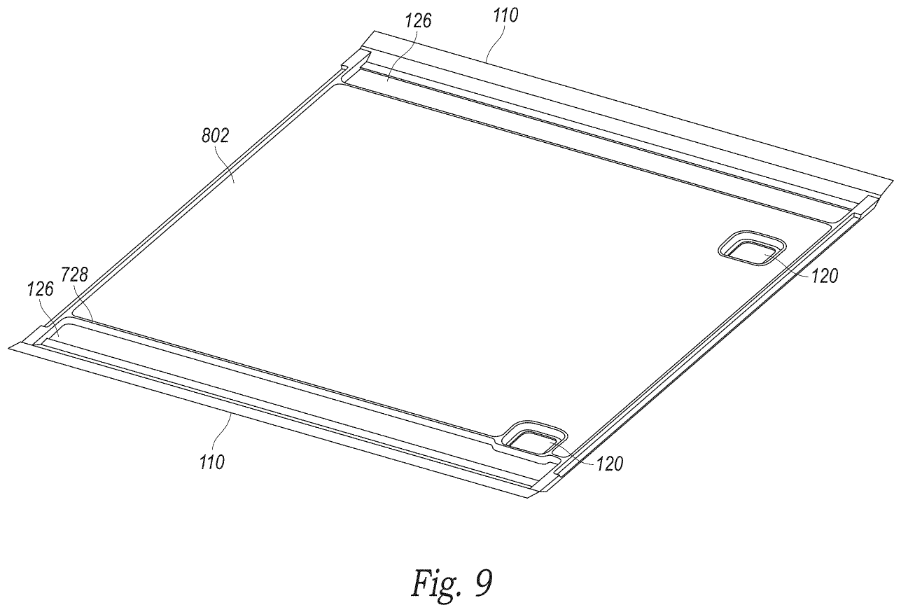

Referring next to FIGS. 8 and 9 together, the view illustrates another embodiment of the present technology, wherein the pit liner 100 has a cover top sheet 802 positioned atop the plurality of raised portions 114. In one embodiment, the cover top sheet 802 is shaped and sized to cover the raised portions 114 and the associated recesses 116, while being radially inward of the perimeter channel 126, such that the perimeter channel remains uncovered. The top cover sheet 802 can be removably retained atop the raised portions 114 to define a portion of the top surface of the pit liner 100. In other embodiments, the top cover sheet 802 is permanently fixed over the central raised portions 114. In this configuration, the cover top sheet 802 can cover some or all of the recesses 116 and block fluid or debris from entering the recesses. The raised portions 114 provide strength and structural stability to the pit liner 100 to support cargo on the pit liner 100. The cover top sheet 802, when permanently affixed in place, may be RF welded, heat sealed, adhered or otherwise permanently affixed around the periphery of the raised portions 114, but radially inward of the perimeter channel 126. Accordingly, fluid or debris will collect in the perimeter channel 126.

In another embodiment, the cover top sheet 802 can be removable, which allows the cover top sheet 802 to be easily and quickly replaced if damaged without having to take the aircraft out of service. The embodiment with the removable cover top sheet 802 can also be configured so the recesses 116 between the raised portions 114 can be used to collect liquid, debris and/or other leakage in addition to the channel 126. The recesses 116 can be cleaned out by removing the cover top sheet to provide access to the recesses.

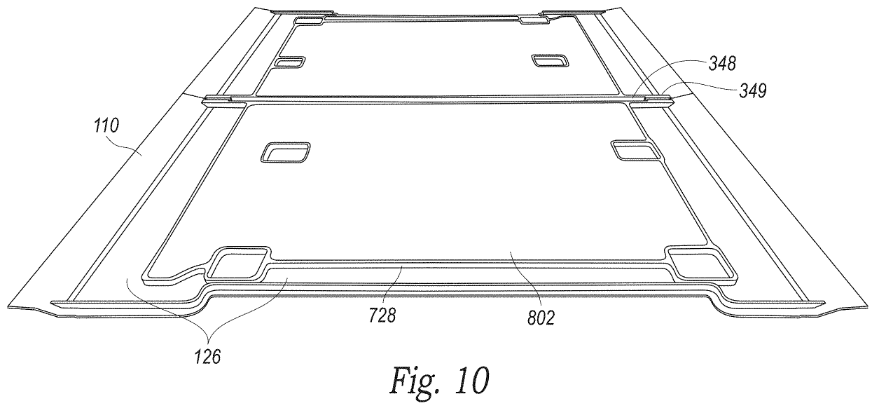

FIG. 9 is a top isometric view of the pit liner 100 and the cover top sheet 802 fully installed. As the view illustrates, the cover top sheet 802 can also include a plurality of apertures or openings configured to align with the plurality of apertures or openings 120 of the pit liner 100. Alternatively, the cover top sheet 802 need not include the plurality of apertures or openings, creating a cover top sheet without direct access to the anchor points. FIG. 10 is a top isometric view of another embodiment of the present technology. Two adjacent pit liners 100 interconnected, such as with the clip 348, in a generally planar orientation to cover a larger surface area of the cargo pit floor. The upper surfaces of the adjacent and interconnected pit liners 100 are planar so that cargo can be smoothly and easily slid across the pit liners and the joint between the pit liners.

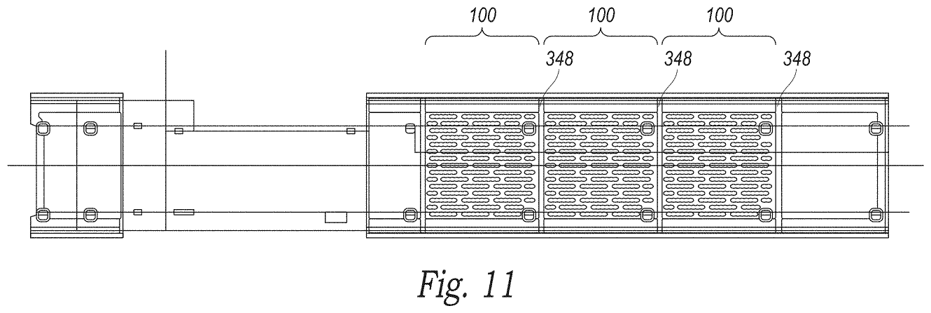

As shown in FIG. 11, multiple pit liners 100 may be connected in a planar arrangement to cover all or a portion of the floor panels in a cargo hold. The plurality of the pit liners 100 can be positioned releasably interlocked with each other, such as with the clips 348, to create a continuous, or at least approximately continuous, cover over the pit floor. The interconnected pit liners 100 protect the floor and retain the fluid and debris from cargo placed into the cargo hold. In one embodiment, adjacent pit liners 100 can be connected using a removable retention clip 348 that attaches to the respective leading and trailing edges of adjacent pit liners 100. Individual pit liners 100 may be removed and replaced, or the entire set of pit liners 100 can be removed and replaced quickly and easily without requiring a significant delay in operation of the aircraft.

References throughout the foregoing description to features, advantages, or similar language do not imply that all of the features and advantages that may be realized with the present technology should be or are in any single embodiment of the invention. Rather, language referring to the features and advantages is understood to mean that a specific feature, advantage, or characteristic described in connection with an embodiment is included in at least one embodiment of the present technology. Thus, discussion of the features and advantages, and similar language, throughout this specification may, but do not necessarily, refer to the same embodiment. Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements. Further any specific numbers noted herein are provided by way of example only. Accordingly, alternative implementations may employ differing values or ranges.

From the foregoing, it will be appreciated that specific embodiments of the invention have been described herein for purposes of illustration, but that various modifications may be made without deviating from the spirit and scope of the various embodiments of the invention. Further, while various advantages associated with certain embodiments of the invention have been described above in the context of those embodiments, other embodiments may also exhibit such advantages, and not all embodiments need necessarily exhibit such advantages to fall within the scope of the invention. Accordingly, the invention is not limited, except as by the appended claims.

Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or in a continuing application.

I claim:

1. A cargo floor liner for protecting cargo holds, comprising:
a liner body having a central portion and a perimeter portion around the central portion, the liner body configured to removably cover and protect a floor of the cargo hold;
a raised border projects away from the liner body along at least a portion of the perimeter portion of the liner body;
a plurality of projections extending away from the central portion of the liner body and being spaced apart to define a plurality of recesses configured to capture and block liquid or debris from the floor of the cargo hold.

2. The cargo floor liner of claim 1 wherein the recesses are first recesses, and wherein a portion of the plurality of projections are adjacent to one or more portions of the raised boarder to define one or more second recesses adjacent the perimeter portion, wherein the one or more second recesses are configured to capture and block liquid or debris from the floor of the cargo hold.

3. The cargo floor liner of claim 2 wherein the first recesses are in fluid communication with the second recesses.

4. The cargo floor liner of claim 2 wherein the first recesses are out of fluid communication with the second recesses.

5. The cargo floor liner of claim 1, further comprising an absorbent material removably retained within one or more of the plurality of recesses.

6. The cargo floor liner of claim 5 wherein the absorbent material has a shape and size substantially corresponding to one or more of the plurality of recesses.

7. The cargo floor liner of claim 5 wherein the absorbent material has an uppermost surface positioned below an uppermost surface of the plurality of projections.

8. The cargo floor liner of claim 1 wherein the central portion of the liner body has one or more openings configured to provide access to anchor points on the floor of the cargo hold.

9. The cargo floor liner of claim 1 wherein the liner body has opposing left and right edge portions configured to be positioned adjacent to the sidewalls of the cargo hold, and further comprising side flaps coupled to the raised boarders adjacent to the left and right edge portions, wherein each the side flap extends laterally away from the raise boarder and is configured to extend along and cover a portion of a respective one of the sidewalls of the cargo hold.

10. The cargo floor liner of claim 1 wherein the liner body has opposing left and right edge portions configured to be positioned adjacent to the sidewalls of the cargo hold, and further comprising a side flap coupled to the raised boarder adjacent to the left or right edge portion, wherein the side flap extends laterally away from the raise boarder and is configured to extend along and cover a portion of one of the sidewalls of the cargo hold.

11. The cargo floor liner of claim 10 wherein the side flap is removably attached to the raised board and can be separated from the raised boarder and the liner body.

12. The cargo floor liner of claim 10 wherein the side flap is configured to be sealably connected to the sidewall of the cargo hold to block fluid or debris from migrating to under the liner body.

13. The cargo floor liner of claim 1 wherein a portion of the liner body's perimeter portion defines a rear edge portion, and further comprising an angled ramp configured to slope to the cargo floor and define a ramped transition between the cargo floor and upper surfaces of the projections.

14. The cargo floor liner of claim 1 wherein the plurality of projections are hollow.

15. The cargo floor liner of claim 1, further comprising fillers within the projections, wherein the projections are not hollow.

16. The cargo floor liner of claim 1, further comprising a cover top sheet positioned over at least a portion of the central portion of the liner body and covering one or more of the projections.

17. The cargo floor liner of claim 17 wherein the cover top sheet is radially inward of the raised boarder, wherein the cover top sheet does not cover the recesses adjacent to the raised boarder.

18. The cargo floor liner of claim 17 wherein the cover top sheet is permanently affixed over the central portion of the liner body and atop a plurality of the projections connected to the central portion of the liner body.

19. A cargo floor liner assembly for use on a floor of a cargo hold, comprising:
a first liner comprising a first liner body, a first raised border extending around the first liner body, a plurality of first projections extending away from a central portion of the first liner body and spaced apart from each other to define a plurality of first recesses, and a first perimeter channel extending around at least a portion of a perimeter of the first liner body configured to capture fluid and debris;
a second liner comprising a second liner body, a second raised border extending around the second liner body, a plurality of second projections extending away from a central portion of the second liner body and spaced apart from each other to define a plurality of second recesses, and a second perimeter channel extending around at least a portion of a perimeter of the second liner body configured to capture fluid and debris; and
a removable retention clip releasably engaging and holding the first and second liners together in a substantially co-planar orientation.

20. The assembly of claim 19, wherein the first and second liners further comprise contoured retention members formed in adjacent edges of the first and second liner bodies, and wherein the removable retention clip snaps over the adjacent retention members to lock the first liner and the second liner together.
